(19) United States
(12) Patent Application Publication
(10) Pub. No.: US 2026/0087178 A1
(43) Pub. Date: Mar. 26, 2026

(54) Methods and associated computer systems for ensuring the integrity of data

(71) Applicant: KraLos GmbH, Burgdorf (DE)

(72) Inventors: Christian Clemens Greiwe, Burgdorf (DE); Carsten Klein, Burgdorf (DE)

(21) Appl. No.: 19/405,004

(22) Filed: Dec. 1, 2025

Related U.S. Application Data
(63) Continuation-in-part of application No. 18/707,796.

(30) Foreign Application Priority Data
Nov. 8, 2021 (LU) 500837LU

(51) Int. Cl. G06F 21/64; G06F 11/14; H04L 9/40

(52) U.S. Cl. CPC G06F 21/64; G06F 11/1458; H04L 63/1458

(57) ABSTRACT

Method of protecting integrity of data including steps of running web service on primary, secure computer system including original, complete data set created by user. Generating intended state of data of the web service on primary, secure computer system, so intended state of data has frontend data, files and information relevant for visual design and interaction of the web service. Transferring intended data set through secure connection to secondary computer system(s) in potentially insecure network on which the web service is executed. Checking integrity of intended data set by detecting manipulation of the underlying information of intended data by an attacker, after manipulation, manipulated data is placed in quarantine and may be analyzed in further step but is no longer executed and thus cannot cause any damage. Restoring intended state of data at time before manipulation by transferring intended data set stored on primary computer system to secondary computer system(s), so manipulation of data has been detected.

### FIELD OF THE INVENTION

The present invention relates generally to a method and corresponding computer-based devices for securing the integrity of the data for operating a service. In particular, the invention relates to a method for generating an intended state of data that can be stored or secured in a medium or system, for transferring the intended state of the data to a further system, for checking and securing the integrity of the data on the further system, and for enabling subsequent analysis after undesired manipulation of the data. The invention further relates to computer-readable media with computer-executable program products, to computer systems which contain these media and program products, and to a computer network of computer systems, wherein these carry out the method or the individual method steps at least partially or completely.

### STATE OF THE RELATED ART

The present invention relates to the technical field of data processing, in particular it is an invention in the field of IT security. In this technical field of data processing, various techniques are known from the state of the related art.

In particular, IT security must be understood less as a state and much more as a process, as there are always new developments, both on the part of attackers and on the part of users who want to protect their systems, which spread rapidly via the Internet. Various methods have been established for securing computer communication via networks. A computer is a physical representation of a universal Turing machine. It runs a computer program that provides basic functions such as file access, (visual) user interfaces ((graphic) user interface, (G)UI) or network functionalities (operating system, OS). The operating system in turn allows the operation of other software that can be written at a different level of abstraction.

A computer usually consists of at least one central processing unit (CPU), a main memory (RAM) and a permanent memory. So-called smartphones or IoT (Internet of Things) devices, such as webcams, smart lights, thermostats, washing machines, dishwashers, etc. can also be computers according to this definition.

A network is a group of logically separate computer systems that can communicate with each other. If several computer systems are operated on one physical computer and these computer systems can communicate with each other, this is also referred to as a network. If you want to distinguish between a network of computers and a network of computer systems within a computer, the former is referred to as a physical network and the latter as a virtual network. A virtual network (virtual local area network, VLAN) can also be created via a physical network between computer systems that are distributed across several computers.

Networks are primarily used to exchange information between computers. This exchange of information takes place via various (web) services. A (web) service consists of at least one computer program that provides at least one functionality via a network. This can also be a virtual network within a host computer. Web services usually disclose information. The words service, web service or Internet service are used synonymously with web services. Web services are usually characterized by the fact that they can be accessed via certain predefined protocols such as hypertext transfer protocol (HTTP).

In principle, there are various options for operating and scaling a web service. The obvious way would probably be to operate a computer in a network with an operating system and run a web service on this computer. For scaling, you could then first upgrade the computer until it is at the maximum performance level of the current hardware generation. For various reasons, different means of virtualization, in particular virtual machines and so called containers (also known as jails), have become established.

A computer system here therefore refers to any configuration (computer with operating system, virtual machine, container, etc.) that meets the necessary requirements for operating a web service (usually provision of a file system, network functionality and operation of software). To provide software functionality, a computer system comprises in particular media (hardware) with computer programs (computer-readable software) stored on it. A software agent, hereinafter also referred to as agent, refers to a computer program that has a precisely specified, independent behavior, i.e. performs its specific task without external prompting.

A computer system that provides a web service in a network is called a server or web server. A network where you have to assume that a potential attacker has access to another computer in this network, so that the attacker can send any data over the network and thus possibly attack your own computer system, is insecure. In particular, the Internet is an insecure network.

Various techniques are available to secure communication via a potentially insecure network. For example, a technique is known from the state of the related art in which a so-called scatter value (also known as a hash or hash value or checksum) is calculated from data. A so-called scatter value function (hash function) is regularly used for this. Such a hash function is provided, for example, by the secure hash algorithm (SHA). With a hash function, a data block that is not necessarily limited in size can often be mapped to a data block of a fixed size, the hash or hash value. A typical length for a hash is 256 bits, for example. A desirable property of a good cryptological hash function is approximate injectivity and thus approximate collision resistance. The “ideal hash function” is therefore completely linkunique and collision-free and always maps different input data to different hashes. The Transmission Control Protocol (TCP) is a typical use case for a hash function, wherein a hash value is calculated for a larger amount of data. For example, a larger amount of data is to be transmitted via a transmission medium that may not be secure, such as the Internet. For example, a technical error may cause part of the data to be transmitted incorrectly or a third party (attacker) may manipulate this data. If the sender of the data calculates its hash value and makes this hash value available to the receiver, the receiver can verify the authenticity and integrity of the data, provided that the hash value itself is genuine and reliable. Apart from the use of checksums, the use of encryption, especially asymmetric encryption, has become established. This offers the advantage that the key exchange can take place via an insecure network. A private and a public key are generated. Data that has been encrypted with the public key can only be decrypted using the private key. In addition to checking the integrity after a transmission using checksums, there is also the safeguarding of integrity through the use of certificates. This is generally based on the use of asymmetric encryption, in which a web service provides a certificate in which a trustworthy authority (certificate authority) guarantees the identity of the web service (by means of a signature using a certificate). A certificate then usually contains a public key that can be used to encrypt the initial communication with the web service.

However, the hash method has the disadvantage that the method is completely invalidated if the hash value itself is manipulated during a man-in-the-middle attack. In one example, a user A (e.g. Alice) transfers a file to a user B (e.g. Bob) and also the hash value of the file. An attacker E (e.g. Eve) intercepts this communication and replaces the file with a fake file. The forged file contains forged data. In addition, E replaces the hash value of the file with the hash value of the forged file. When B now receives the data and checks it by calculating the hash function of the file itself and comparing it with the hash value, he comes to the conclusion that the data has not been manipulated. Thus, E has successfully manipulated the data without this being detected by B. This cannot necessarily be detected even by common encryption methods such as SSL, as the certificates used for encryption can also be replaced by E, so that both parties communicate with E in encrypted form and assume that the connection is secure.

Man-in-the-middle attacks can be avoided as far as possible by both parties exchanging which certificates they expect from each other beforehand during communication between A and B, thereby ruling out the possibility of an attacker E manipulating the communication. This process is known as certificate pinning. As soon as the communication between two computers is sufficiently protected, it becomes easier and therefore cheaper for a potential attacker to attack one of the communication parties directly in order to intercept or manipulate the communication. It is therefore essential that individual computer systems are also adequately secured. Attacks on web services are particularly attractive to potential attackers because a successful attack can give them access to communications with dozens, hundreds or thousands of the victim's customers, who in turn believe the data loaded is legitimate and trust it.

This results in a particular need for protection for operators of web services, especially as the operator's competitors and other interest groups such as hackers with a profit motive, but also groups such as Anonymous, which attack targets purely on the basis of an ideological drive.

In addition, the introduction of data protection regulations such as the General Data Protection Regulation (GDPR), but also previously in the handling of payment data such as credit card data, poses a considerable economic risk of damage associated with the operation of a web service.

In general, it can be said that when securing computer systems, an approach with as many layers of protection as possible is necessary, as almost any protection system can be overcome, but economically motivated attackers in particular usually attack the simplest targets first, as they are also subject to a profit maximization intention. Many simple and successful attacks are usually more profitable than an attack on a complex secured system.

Therefore, the benefits of further security measures normally outweigh the costs incurred for the security measures. The first layer of protection against an attacker is usually a firewall, which monitors both incoming and outgoing communication on a computer and allows processes on the computer to be assigned to specific protocols, ports, URLs 5 and IP addresses. A blacklisting, i.e. a negative determination of access rights, or a whitelisting, i.e. a positive determination of access rights, can be carried out. Antivirus programs regularly scan the permanent memory of a computer for known malware. To do this, the provider of an antivirus program collects signatures of known malware and often also certain behavioral patterns. The disadvantage of this is that scanning the storage medium in this way is relatively computationally intensive and therefore time-consuming. In addition, the malware must already be known. Another protective measure for securing IT systems is authorization management, which regulates the sensible administration of access authorizations. According to the “principle of least privilege”, applications and processes should only be started with the minimum necessary authorizations. Furthermore, structures in the file system should only be changeable to the extent that this is necessary for the respective technical user (e.g. user for running a web server). This could, for example, have read authorization for the corresponding configuration without also being able to write the configuration. In practice, this measure is very time-consuming and often leads to misconfigurations, as the correct configuration of authorization management is very complex and confusing. Sandboxing is a method in which the operating system usually ensures that an application can only access an area of the file system assigned to it, so that this application cannot manipulate data from other applications and, in particular, other applications. It is therefore basically an automated special application of authorization management.

DE 601 32 833 T2 discloses a method in which data entering a computer system that could lead to possible manipulation is transferred to an isolated sandbox area where it can be analyzed. Cryptographic encryption is used to secure the transmission of the potentially harmful data, which is only removed in the sandbox area. The method is specifically aimed at a computer system that regularly receives data and therefore requires an intelligent check that classifies incoming data as potentially harmful. The method involves checking the entire file as soon as it is transferred to the computer system, so that no data changes need to be monitored or differentiated.

Another option is the isolation of different services into separate computer systems. Instead of providing several services such as webmail, database and website on one computer within an operating system, these services are distributed to different virtual machines or containers, for example, so that a compromised mail server does not automatically lead to the database 5 being compromised.

In addition to the solution using antivirus programs, where a negative authorization list (programs that are not allowed to run) is kept, there is also the option of only allowing certain applications, the integrity of which is often ensured by checksums. This option is known as whitelisting.

Methods are known from US 2020/366696 A1 and US 2001/044820 A1 in which the integrity of web services in particular is monitored in order to do justice to the challenging risk situation on the World Wide Web. In these methods, however, only a previously specified warning is issued to another system in response to an identified manipulation of the web service or the web service is stopped in parts or the manipulated code is removed. This means that the complete web service is not restored. In particular, if it was unclear which part of the web service was compromised and in what way, it is not possible to subsequently analyze the target of the attack and the type of attack while simultaneously restoring the web service.

DE 20 2014 010 889 U1 discloses a method for verifying the trustworthiness of at least one web service on a server that is exposed on the Internet. Web applications hosted there or changes to these web applications are checked for their trustworthiness using a combination of the methods described above, including blacklisting and whitelisting, checking known virus and malware code, and checking for changes to cryptographic hash values, as well as listing and evaluating various data sources with regard to their confidence. Unknown attack methods could still initially overcome the automated checking procedures so that malicious code could be hosted on the server. However, the server described comprises both the verified and unverified web applications as well as the verification criteria for verified web applications, so that successful external access to this server (compare: man-in-the-middle attack) could manipulate the intended state of the hosted web applications and possibly manipulate future verification criteria without being noticed, as it is not a distributed or separate computer system.

A computer system that is protected to a particular extent by the application of other, in particular several complementary methods from the state of the related art and in particular is only accessible to a limited extent from an insecure network such as the Internet is a protected computer system within the meaning of this document.

A particularly high standard of protection in the area of IT security is provided by the socalled zero-trust approach. Zero trust implies that no participant or user, for example of a network, is trusted from the ground up. For example, the zero-trust approach means that requested changes to certain data of a web service are always checked before the change is implemented. In addition to securing a web service, the focus is also on efficiency. Long loading times in particular quickly lead to users “bouncing” and impatiently calling up the website of an alternative provider, but cost-effective scaling also plays a role in the economic operation of web services.

The data provided by a web service is often recalculated in part or in full at the time of the request. Caching is the process by which the generated data, e.g. HTML documents, are stored for a period of time and then delivered again when an identical request is made during this period, without the entire calculation having to take place again. This saves computing power and minimizes the loading time of the data accordingly. Caching for web services is known from US 2005/0193096 A1 and US 2008/0098301 A1.

As already described, when operating a web service, there is sometimes a need to process the load more efficiently, for example to satisfy more users. A key characteristic for the success of a web service is sometimes the loading time before the server provides the user with a response (response time). In order to keep this loading time as short as possible, additional computer systems are usually provided as servers that process requests in parallel and can thus significantly reduce the average waiting time for a large number of requests. Furthermore, operators of an international web service can also decide to operate computer systems in other data centers in order to reduce the distance to their customers so that the loading times for the customer are not affected by imponderables such as physical limitations of the transmission lines, peering agreements between different Internet service providers (ISPs) or similar. These methods are also generally suitable for increasing the reliability of a web service. Methods of the type described here are called “load balancing” or load distribution. In addition to the methods already described, other technologies that can play a role in the operation of a web service should be mentioned for the sake of completeness: Bittorrent is a protocol for exchanging files on the Internet. Files are exchanged directly between computers via a network without the need for a central authority for coordination. The protocol also uses checksums to check parts of files for correct transmission. Some providers offer data synchronization based on this protocol. This is also suitable, for example, for synchronizing the data for operating a web service between different computer systems that jointly implement load balancing. In many networks, especially company networks, there is also a so-called proxy, which receives requests from computers in the network to the Internet and forwards them to the corresponding servers. This is usually done for security reasons or for the purpose of prohibitions within the network. By using a proxy, the IP address of a computer can also be disguised, as the computer addressed only receives the IP address of the proxy. A reverse proxy is the opposite. It is usually connected upstream of the actual web service when operating a web service in order to secure the web service, to conceal certain functions of the web service from the Internet or to implement load balancing.

### Task

The task of the present invention consists in securing the integrity of data, such as files or data stored in databases on servers that offer a web service and are exposed in a network. Furthermore, it is the task of the present invention to effect an immediate isolation of compromised data in the event of manipulation, in particular on a server or on a computer readable medium. The isolated data should not be able to cause any damage to the computer system, but at the same time should be analyzable. In addition, the data and the web service should be restored to a state prior to manipulation.

### Solution

According to the invention, the task is solved by a method for protecting the integrity of the data comprising the following steps:
a) Generating (S01) an intended state (3) of data of a web service (2) on a first/primary secure computer system (herein also referred to as primary system or primary computer system) (1);
b) Transferring of part of data (S02), in particular data which belong to the frontend, through a secure connection to one or more servers (also referred to herein as secondary computer systems) (7) in a potentially insecure network to provide a web service (8);
c) Checking (S03) (20) the integrity of the transferred data, preferably by an agent in the secondary computer system (11), in such a way that tampering with the transferred data, in particular the files and data, by an attacker is detected;
d) Restoring (S04) (21), in particular immediate restoring, of the intended state of the data (19) on the secondary system at the time before tampering, in particular unintentional tampering, using secure data of the primary system; wherein preferably between steps S03 and S04, i.e. between the step of checking (S03) and the step of Restoring (S04) after a manipulation (17), the data of the secondary system is placed in quarantine, so that it is subsequently analyzed but can no longer be executed and thus cannot cause any damage.

In order to protect the process from misuse, the present process also includes in one embodiment a self-destruction mechanism that is activated as soon as a possible change is detected.

Further advantageous embodiments can be found in the sub-claims and the description.

### General Advantages

The method according to the invention significantly increases security when operating a web service, while considerably reducing the technical effort required to secure it and thus the costs of operation. The software architecture principles reduce or eliminate the generally known technical risks when operating a web service without in-depth specific knowledge of the program used. In its embodiment according to the invention, the tamper protection corresponds to the zero-trust principle according to the principle “do not trust, always verify”, but at the same time allows a subsequent analysis of potential attacks. Furthermore, the method according to the invention increases the technical effort and thus the costs for a potential attacker enormously, as this
a) must know that the web service is protected by this method,
b) cannot attack the agent (11), as the agent in the secondary system is itself protected by the method,
c) he cannot use the web service (8) to attack other users without being detected,
d) cannot attack the primary system (1) either, as this communicates exclusively with the agent via a secure connection and is not otherwise connected to the insecure network.

Due to the significantly increased costs for the attacker, it cannot be assumed that such a protected secondary system (7) would continue to be attacked, as attackers are also subject to economic constraints and thus have to maximize profit per effort.

### DETAILED DESCRIPTION OF THE INVENTION

In the following detailed description, reference is made to the accompanying drawings, which form a part hereof, and in which is shown by way of illustration specific illustrative embodiments in which the invention may be practiced. In addition, the following disclosure provides many different embodiments, or examples, for implementing different features of the present disclosure. Specific examples of components and arrangements are described below to simplify the present disclosure. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Unless otherwise stated, a term as used herein is given the definition as provided in the A Dictionary of Computer Science, Oxford University Press, 2016 (7 ed.), ISBN 9780199688975.

It is to be noted that the term “a” or “an” entity refers to one or more of that entity; for example, “an unit,” is understood to represent one or more unit. As such, the terms “a” (or “an”), “one or more,” and “at least one” can be used interchangeably herein.

Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, display devices, or the like.

The term “data” used herein generally relates to information, in any form. In particular, the term data comprises (characteristic) information, web resources, documents, files, images, backend and frontend information and the like.

“Computer systems” may include one or more “Computing devices” which typically comprise one or more processors which are able to process data from e.g., I/O components or memory. The one or more processor may be coupled to one or more display and/or input devices, such as a keyboard, mouse, speaker, printing device, and/or pointer, communication circuitry and the like. The display device, may be for example a monitor that displays information for viewing by a user of computing devices. The display device may present rich content, e.g., a display area populated with representations of folders and/or digital communications or other forms of media such as audio signals, haptic signals, as well as uniform resource locator (URL) links that are active or deactivated. The input device for example a keyboard and a mouse are used to control a screen pointer provided by the graphical user interface on the computing device. I/O ports allow computing devices to be logically coupled to other devices including I/O components. Some of the devices including I/O components may in some aspects of the invention be built in. The computing device may also include a program product including a machine-readable program code for causing, when executed, on the computing device to perform steps of the present invention. The program product may include software which may either be loaded onto the computing device or accessed by the computing device. However, the software may also be accessed by the computing device using a web browser. The access of the software via the web browser via the computing device may be performed using the internet, intranet, extranet, haste server, internet cloud and the like. One or more of the computing devices may also be connected to further devices. For example, in a company network a computing device may comprise or be connected to one or more of a client, a desktop computer, a server, a mobile computing device such as a tablet computer, a smartphone, or laptop computer, and a dumb terminal interfaced to a cloud computing system. However, the Computer system and the computing devices are not limited to a particular type of network to which they are connected. Those skilled in the art will appreciate that the system and method described herein can be applied to virtually any network without departing from the scope of the claims and specification. In one embodiment a network connecting the computing devices include, but is not limited to, general-purpose systems such as ISDN (Integrated Services Digital Network), special-purpose systems such as LAN (local area network) or a WAN (wide-area network).

According to the method according to the invention, an intended state of data is generated on a primary computer system in a protected network (S01). This data comprises, in particular, files for providing a web service and data from databases. By storing the data in the protected network, the intended state of the data cannot be directly attacked or manipulated.

In particular, the original and complete state of data which is generated on a primary computer comprise an original state of data, which has been created by an user. Accordingly, the user is the developer of the data. These data on the primary computer comprise in one aspect of the invention all information for an application, e.g. a website. The information comprise, but are not limited to the frontend and the backend. Frontend comprise information for visual design and interaction of a website, such as user interface (GUI), design, navigation, layout, displaying text, images, buttons, and/or menus. The programming languages for the frontend are usually HTML, CSS, and/or JavaScript. However, the backend is the invisible part of an application, such as a website, that enables functionality, data processing. Databases, database management, authentication, logic, and/or connection to other systems. Accordingly, the backend runs in the background and contains the databases and code necessary for displaying products or processing orders. The programming languages for the backend is usually Java, Ruby, Python, PHP, .NET, or others. The so called intended state is also generated on the primary computer system. This state comprises information which are not relevant for the, e.g., functionality, data processing, databases, database management, authentication, logic, and/or connection to other systems. Usually the intended state comprises frontend data, files and information relevant for visual design and interaction of a website or a web service. In a preferred embodiment, within the intended state also dynamic data are converted to static data.

In a next step of the method, part of the data, in particular data which belong to the frontend, i.e. the intended state, is transferred to a secondary computer system on which the web service is executed (S02). This secondary computer system is exposed in an insecure network, for example on the Internet, and is therefore vulnerable. Important data, such as backend information which comprise information for functionality, codes and data processing information stay located on the primary computer system in a protected network (S01) and are not transferred to the insecure secondary computer system (S02). Accordingly, third persons, defrauder or the like have no access to relevant information of the application, e.g. the website. The access on the secondary computer system only includes transferred data, in particular, frontend information.

The integrity of at least one secondary computer system in the insecure network is advantageously checked by a computer program (hereinafter: agent) (S03). Manipulated data is placed in quarantine, preferably by the agent, after an unintentional manipulation has been detected, so that the data can be analyzed afterwards but can no longer be executed, which advantageously prevents further damage after the check. According to the invention, this manipulation can be designed in such a way that manipulations are always placed in quarantine, even if it is not clear whether the manipulation is of a hostile nature. A system protected in this way is advantageously secured in accordance with the zero-trust approach and is advantageously suitable for security-critical web services in exposed networks. Placing the data in quarantine serves to protect the computer system. For this purpose, conspicuous (manipulated) data, e.g. a corrupted file, is moved to a directory, preferably on a server, from which a program contained in this file cannot be started (isolation). Preferably, this directory is located on another separate system, wherein this system has no access rights to other systems and does not allow the execution of external programs. Alternatively preferred, isolation is achieved by sandboxing on the secondary system. Alternatively preferred, isolation is achieved by restrictive authorization management of a directory on the secondary system.

Following manipulation, the agent restores the intended state of the data of the secondary system from the primary computer system S01 (S04), wherein the original data are stored. However, these restored data within the secondary system comprise only information to the user interface (GUI), design, navigation, layout, displaying text, images, buttons, menus and the like, i.e. frontend data. Restoring the state is preferably initialized immediately when the manipulation is detected in order to be able to offer the web service again as quickly as technically possible.

According to a preferred embodiment of the present invention, between steps S03 and S04, i.e. between the step of checking (S03) and the step of Restoring (S04), the data is placed in quarantine after an unintentional manipulation has been detected, so that the data can be analyzed retrospectively but can no longer be executed, which advantageously prevents further damage after the check.

In a preferred embodiment, changes to the data, as an example of manipulation (17) of data, are detected based on cryptographic methods.

Signatures using certificates, for example, are a suitable cryptographic method. This method is standardized and less prone to errors, so that false positives should not occur.

Alternatively, it is preferable to use hash values such as SHA256, SHA512, MD5 with the lowest possible collision probability to ensure that the file does not undergo any changes, which may be slightly more error-prone, but could also be more secure.

In a further preferred embodiment of the invention, checking (S03) (20) the integrity of the data (also referred to as verifying), in particular of files, information, web resources, documents, files, images, frontend information, or parts of files, takes place immediately after manipulating the data, in particular the files, information, web resources, documents, files, images, frontend information or parts of files.

This can be achieved, for example, by regularly checking the integrity, in particular more frequently than once per hour, in particular more frequently than once per 30 minutes, in particular more frequently than once per 10 minutes, in particular more frequently than once per 5 minutes, in particular more frequently than once per minute, in particular more frequently than once per second, furthermore in particular more frequently than once per 500 milliseconds, furthermore in particular more frequently than once per 100 milliseconds, furthermore in particular more frequently than once per 10 milliseconds, furthermore in 15 particular more frequently than once per millisecond, furthermore in particular more frequently than once per 500 microseconds, furthermore in particular more frequently than once per 100 microseconds, furthermore in particular more frequently than once per 100 microseconds, furthermore in particular more frequently than once per 10 microseconds, furthermore in particular more frequently than once per microsecond, furthermore in 20 particular more frequently than once per 500 nanoseconds, furthermore in particular more frequently than once per 100 nanoseconds, furthermore in particular more frequently than once per 10 nanoseconds, furthermore in particular more frequently than once per nanosecond, furthermore in particular more frequently than once per 500 picoseconds, furthermore in particular more frequently than once per 100 picoseconds, furthermore in particular more frequently than once per 10 picoseconds, furthermore in particular more frequently than once per picosecond, furthermore in particular more frequently than once per 500 femtoseconds, furthermore in particular more frequently than once per 100 femtoseconds, furthermore in particular more frequently than once per 10 femtoseconds, furthermore in particular more frequently than once per femtosecond.

In the case of regular file checks, the check interval should preferably be in the order of magnitude of the execution time of the necessary CPU clock cycles, depending on the check algorithm used.

Regular checks within very short time intervals reduce the time an attacker has to reach their targets, so that in the best case scenario they cannot cause any damage. Since many attacks require a manual analysis by the attacker after a (partially) automatic infection of the attacked system, a significantly higher level of security can be achieved with checks with an interval of just a few minutes. By further shortening the check interval, even highly automated attacks can be detected and blocked before any damage can occur.

Alternatively, the immediacy of the check can be ensured by using watchdogs. Modern operating systems allow the registration of a so-called watchdog. This informs the operating system that a specific process should be started if a file or the contents of a directory are manipulated. This process is known as a watchdog.

In one embodiment of the method according to the invention, a watchdog can be used to provide an immediate response to manipulation of the data without blocking a lot of resources by constantly checking. This is therefore a resource-saving implementation for securing the immediacy of checking the manipulated data.

It may be provided in the method that data defined by a user (e.g. files, parts of files and/or other data) are registered for checking (S03) for manipulations or that data defined by a user (e.g. files, parts of files and/or other data) are excluded from checking (S03) for manipulations. In a further embodiment of the invention, the user of the method according to the invention can therefore determine that data, files or parts of files (file parts) of the web service are checked in step S03, i.e. in the step of checking (S03), and are isolated in the event of manipulation (blacklisting). In a preferred further embodiment of the invention, the user of the method according to the invention can specify that data, files or parts of files of the web service are not checked in step S03, i.e. in the checking step (S03) (whitelisting). Both embodiments of the method represent options for deviating from the intended principle of placing all manipulated files in quarantine according to the zero-trust approach. The whitelisting approach is the preferred embodiment of the invention, as it allows the user to accept known changes in order to prevent false positive tampering cases—i.e. those that were not hostile. At the same time, the zero-trust approach remains consisting of all unlisted tampering cases, including potential unknown cases.

In a further preferred embodiment, in step S01 of the method, i.e. in the step of generating the intended state (S01), supposedly dynamic data of the web service, in particular files, such as HTML pages rendered by PHP, for example, are transferred to the secondary system as static files, such as HTML, JSON or XML files, insofar as the operated service allows this. This is helpful in order to execute possible security gaps in the executable program code, as far as possible, exclusively on the primary, secure system and to improve the loading times and reliability of the service.

Login pages, such as shop systems using, e.g., PayPal, require a unique identification of the user. In one embodiment the method and system according to the present invention allows an unique identification of the user through the primary computer system. A session within a shop system is always established on a web server. The browser is assigned a session ID, which the web server uses to uniquely identify the browser. This session ID is stored in the browser and sent with every request to a server. The server's session system can store any amount of data as a key/value system. Based on the session ID and, typically, other information such as cookies and the like, the server can then uniquely identify the user. In case a user accesses the server with a browser, the user receives a session ID which was generated by a target server. The target server in turn receives a session ID from the source server. Without intervention, every user would receive the same session ID from the source server and could see the data of other users. However, in one embodiment the method of the present invention is capable of requesting a unique session ID from the source server, here the primary computer system, for each user, thus separating users and clearly identifying each session on the target server, i.e. the secondary computer system, for an individual user.

It may be provided that the triggering of the transferring of data from the primary computer system (1) to a secondary computer system (7)
a) is triggered manually, or
b) is triggered automatically on a time-controlled basis, or
c) is triggered automatically after the intended state of the data is changed.

In one possible embodiment of the method according to the invention, the transferring of data from a primary to a secondary system takes place manually. This gives the website operator full control over which data is transferred and when.

In a preferred embodiment, the transfer of data is automatically time-controlled, which ensures that the web service in its publicly accessible form is regularly updated to the current intended state of the data. The time control can in turn correspond to a random pattern so that a potential attacker cannot predict when a new transmission will take place. In a particularly preferred embodiment of the method, the data is transferred automatically after the intended state of the data has changed. This has the advantage that the publicly accessible version of the data always corresponds to the most recently updated status. The transfer of the data can optionally comprise a) the entire intended state, but preferably b) only the difference to the previous intended state of the data from the primary to the secondary system. According to a), the possibility of errors due to an incorrect delta calculation is more limited, but b) offers a bandwidth saving, which is particularly advantageous for extensive data. In addition, the incremental update option offers the advantage that even compromised communication between the primary and secondary systems does not allow any conclusions to be drawn about all the data for the operation of the web service. According to a preferred embodiment of the invention, only the difference between the intended state and the previous intended state of the data is transferred from the primary computer system (1) to the secondary computer system (7) in the step transferring of data (S02). In a further preferred embodiment of the invention according to a), each change of an intended state (3) and each transmission to the secondary computer system in the step transferring of data (S02) is stored in an audit-proof manner, thereby enabling subsequent auditing.

In a further embodiment of the method, the change of intended states and their transmission is stored in an audit-proof manner, enabling subsequent auditing.

The auditing of changes is a practice in which it can be traced retrospectively when which changes were made and by whom. To do this, it must be possible to store the data in an audit-proof, unchangeable format.

This is preferably done using a blockchain, as information is stored and transmitted in an audit-proof manner in a decentralized manner, which means that 5 S02 can also be implemented at least in part. Blockchain is a technology that stores information in a similar way to a database. The information is not stored in a centralized location in a computer system, but is located on many systems simultaneously. All instances of the database contain all the information and the entire history can be accessed at any time. As long as there is no consensus in the network of all instances, historical entries cannot be deleted. The method according to the invention also protects data in a database. The integrity of the data in the database is secured by
a) either after each desired manipulation of the data by the web service, the corresponding query is first checked for malicious entries (e.g. SQL injections, or changes to prohibited data records, such as database users or rights), then transferred to the primary system in a secured manner and the changes made to the data are subsequently mirrored to the secondary systems, or
b) after each desired manipulation of the data by the web service, the query is first checked for malicious entries (e.g. SQL injections, or changes to prohibited data records, such as database users or rights) and then secured and transferred to the primary system, and read accesses to the database are also checked by the agent and transferred to the primary system, so that no database is required in the secondary system, or
c) the database on the secondary system is regularly checked for unintended changes to prohibited data records such as database users or other data that does not need to be processed by the service.

According to a preferred embodiment of the invention, the data for generating the web service is selected from data in a database, and wherein the integrity of the data in the database (4) is secured by
a) either each query to the database (13) is first checked, in particular by the agent (11), for malicious entries (e.g. SQL injections, or changes to prohibited data records, such as database users), then secured and transmitted (14) to the primary database (4) of the primary computer system (1) and subsequently the changes made are mirrored to the secondary database (9) in the secondary computer 5 system (7), or
b) each request to the database (13) is first checked, in particular by the agent (11), for malicious input and then transmitted (14) in a secured manner to the primary computer system (1), and read accesses (15) to the database are also checked, in particular by the agent (11), and transmitted (16) to the primary computer system, so that no database is required in the secondary system (7), or
c) the database on the secondary system (9) is regularly checked, in particular by the agent (11), for changes to prohibited data records that are not to be processed by the web service (8).

The protection of data in databases is particularly relevant because it can prevent well-known problems such as SQL injections. SQL injections are a major security problem in which an attacker can gain access to any data in a database if the software accessing the database has not been appropriately secured. No state of the related art method protects any third party software from such attacks.

This is particularly relevant because small and medium-sized companies in particular often use software, e.g. to operate a web store, that they do not develop themselves, which means that they have no information about possible security vulnerabilities. In a preferred embodiment, several secondary systems are operated in parallel in order to distribute the load by means of load balancing and thus minimize loading times of the operated service and furthermore advantageously increase reliability. Consequently, several secondary systems (7) can be operated in parallel in order to advantageously enable load balancing, in particular of the web application.

In a further preferred implementation of the method with multiple secondary systems, after a breach of the integrity of a datum, the entire secondary server or system (7) on which the integrity has been damaged is isolated to enable subsequent analysis of the entire attack. In this case, isolation also includes stopping the entire system to prevent any malware that may be running from removing its traces. This makes it easier to attribute the attack.

In a further preferred implementation of the method, if the entire secondary system is isolated, the system is not stopped in order to analyze the further mode of action of the malware that may be running. In other words, the isolated secondary system is preferably not terminated, but continues to operate in isolation for the purpose of analyzing the malware.

This method can also be used advantageously if it can be assumed that the malware removes its traces when the program is terminated. It is also preferable to start a replacement system if a secondary system is isolated in order to maintain the load balancing function.

In a further embodiment of the method, a reverse proxy is also introduced to prevent so called (D)DoS attacks. This can be done in an embodiment with one or more secondary systems. For example, it may be provided that a reverse proxy is used on the secondary system (7) in order to advantageously protect the web service (8) from (D)DoS attacks.

According to a preferred embodiment, protection against (D) DoS is implemented in addition to load balancing. Denial of Service (DoS) is an attack strategy on web services in which attackers attempt to send as many requests as possible to the server at the same time, which the server cannot answer all at the same time.

In this way, the service is overloaded and customers of the service sometimes receive no response at all, an error, or the response takes a very long time. This can cause considerable damage to the operator, especially if the attack lasts longer, as revenue is usually lost during this time because potential customers are unable to access the web service. If the attack comes from many distributed computer systems, it is referred to as a Distributed Denial of Service (DDoS). In recent years in particular, Internet of Things (IoT) devices such as smart light bulbs or webcams have been used for such DDoS attacks. This is particularly possible because their software is only very rarely provided with security updates. By using the method according to the invention in such IoT devices, they would also be protected and the use of such devices for such attacks would be made significantly more difficult.

Furthermore, a reverse proxy is implemented in the method according to the invention, which serves, among other things, to protect against (D)DoS attacks in order to advantageously contribute to lower loading times and to avoid a failure of the service with associated loss of revenue.

In particular, several secondary systems can also be used for the purpose of load balancing and reducing loading times through clever spatial distribution.

In a preferred version of the method, the manipulated data is analyzed within the isolation after manipulation has been performed. The data analysis can serve several possible objectives. In one embodiment of the method, the objective of the analysis is to determine the target of the attack within the web service. This is advantageous if the manipulated data has been isolated without a more detailed threat analysis, for example to ensure that a secure state is established particularly quickly. In this case, a target analysis can be carried out retrospectively. The analysis can advantageously identify possible vulnerabilities in the system that an attacker wanted to exploit.

In a further embodiment of the method, the aim of the analysis is to obtain data on attack patterns from the manipulation. Advantageously, knowledge databases of attack patterns can be compared and expanded in order to record new threats or identify possible attackers. It can also be advantageous to expand the database for other security systems that do not isolate every manipulation across the board, but instead attempt to differentiate between malicious and benign manipulations (see blacklisting, antivirus programs in the state of the related art). Collecting or selling such data results in an economic advantage according to the invention.

In one version of the method, the analysis of the manipulated data is carried out manually. With the involvement of security experts, a data set of particularly high quality can be created, especially with regard to the identification of the attack target and the classification of manipulation as malicious or non-malicious.

In a particularly preferred version of the method, the analysis of the manipulated data is carried out automatically. Statistical analysis methods can be used for this, in particular the clustering of manipulation types, or statistical similarity analyses with known attack types from knowledge databases. In a particularly preferred embodiment, machine learning methods are used for data analysis, especially for clustering manipulation types and classifying the degree of maliciousness of attacks. In the case of manipulation of a semantic nature (e.g. SQL injection), in a particularly preferred embodiment of the method, deep learning methods are used for language processing to detect patterns within the manipulation or to perform maliciousness classification. Any automated data analysis can significantly increase the efficiency of data utilization. In particular, by collecting and using large amounts of manipulation data, automated data analysis methods also offer increasing precision, resulting in an economy of scale.

The method according to the invention is realized on various computer systems of a primary as well as at least one secondary system, by one or more computer programs.

In one preferred aspect of the present invention the method comprises a self-destruction function. Using the present method it is possible to create fake websites, which may be used for phishing or other types of cyberattack in which fraudster attempt to steal personal and sensitive data. This data may include, e.g., login credentials, credit card numbers, bank details by impersonating trusted sources or others. To prevent misuse, of the present method, the method is preferably used for users with registered data with the provider. In addition, the present method is preferably delivered as a computer program product, herein also referred to as a first computer program product, comprising instructions which, when the program is executed by a computer or a computer system, cause the computer or computer system to perform the steps of the method as described before or a system performing the method. In one aspect of the invention, the method is provided to a user as a computer program product, in particular software, which the user can install independently. Due to the fact that the user in a preferred aspect may install the software independently, the method preferably includes a mechanism that prevents any potentially malicious use. Therefore in one aspect of the present invention the method prevents the computer program product from running on servers other than those used, stored or deposited by the user.

In a preferred embodiment the user has to specify a domain or IP (Internet Protocol) address. In addition, the user may also indicate whether there will exist only one instance or several instances, for example for subdomains. Based on the information the method will be preferably delivered as a computer program product in an installer version, such as an installer software.

After installation of the computer program product, the method runs on a computer system with a defined domain or IP (Internet Protocol) address and one or more instances. At this time, in one aspect of the present invention the method includes a further step, i.e. contacting the deposited server (also called cockpit server). Contact is preferably made at regular or irregular intervals. These irregular intervals are, for example, preferably one or more per week, one or more per day, one or more per hour, more frequently than once per 30 minutes, more frequently than once per 10 minutes, in particular more frequently than once per 5 minutes, in particular more frequently than once per minute, in particular one or more times between a femtosecond and a second. In case
a) the cockpit server cannot be reached;
b) an incorrect response is received by the cockpit server; and/or
c) a change to the source code of one of the data, information or files of the computer program product has been detected,
   the self-destruction function is triggered.

In a preferred embodiment, the availability of the cockpit server is checked several times. If the cockpit server cannot be reached, it is assumed that a network disconnection has occurred. To prevent the computer program product or method from becoming unusable when the system is temporarily disconnected, for example from the Internet, a corresponding timeout can be set. The timeout or checking of the connection to the primary system or the cockpit server takes place in particular 1 to 100 times, in more particular 1 to 50 times, most preferably 1 to 10 times. In a preferred aspect, the availability of the cockpit server is checked three times. In a particular preferred aspect, the value is configurable. If the connection check is negative, i.e., the server is unavailable for a certain period of time (timeout), self-destruction is initiated. During self-destruction, a so-called “shuttle( )” function is preferably started. This function preferably shuffles the entire code of all involved scripts, in particular using the PHP function “str_shuffle( )”, rendering entire code of all involved scripts unusable and/or impossible to recover.

In one aspect of the invention, the source code of one of the data, information or files which are necessary to perform the steps for checking the integrity of data of the present method or in the computer program product are checked regularly. The check for validity may be performed in irregular or regular intervals. Corresponding intervals are, for example, but not limited to, preferably one or more per week, day, hour, more frequently than once per 30 minutes, more frequently than once per 10 minutes, in particular more frequently than once per 5 minutes, in particular more frequently than once per minute, in particular one or more times between a femtosecond and a second. The check for validity may be performed directly through the computer program product performing the above-described method (webouncer), the webserver and/or the primary computer system or another deposited server (cockpit server). If an irregularity is detected, self-destruction is initiated. During self-destruction, the so-called “shuttle( )” function is also preferably started in this case, wherein entire code of all involved scripts of the underlying method and/or computer program product, preferably using the PHP function “str_shuffle( )” is used to render the entire code of all involved scripts unusable and/or impossible to recover.

In a further embodiment an external check, usually from the Cockpit server, is performed to verify that the system is still online (live check). This live check is preferably performed at irregular intervals. These irregular intervals are, for example, preferably one or more per week, one or more per day, one or more per hour, more frequently than once per 30 minutes, more frequently than once per 10 minutes, in particular more frequently than once per 5 minutes, in particular more frequently than once per minute, in particular one or more times between a femtosecond and a second. If anything, suspicious is found the self-destroy function is initiated, wherein in particular the “shuttle( )” function is started, wherein the entire code of all involved scripts of the underlying method, system and/or computer program product, preferably using the PHP function “str_shuffle( )” is used to render the entire code of all involved scripts unusable and/or impossible to recover.

In a further preferred aspect of the invention, a verification function of the Fileserver.php script is called at regular intervals by user requests. If this internal verification function detects changes compared to the stored hash values, the self-destroy function is initiated. The self-destroy function is started due to the fact that these changes are based on the actions of third parties. Preferably, the hash values of each file are composite hashes consisting of two values, in particular one MD5 and SHA128. This combination makes it more difficult for fraudsters to produce the exact hash values when manipulating the data. In addition, in a further embodiment the hash values are stored in encrypted form.

In a preferred version the method also comprises a watchdog call. The watchdog allows a direct reaction to a probable change or even if someone merely accesses a file of the computer program product or system. In particular, the watchdog is running on or more designated servers. Therefore, the watchdog serves as an additional measure to ensure that no hacker or fraudster can gain access to and/or cause damage to the target system and/or the primary computer system.

Accordingly, in a preferred embodiment the method comprises a self-destruction function, comprising the following steps:
a) contacting a cockpit server;
b) receiving and reviewing responses of a cockpit server; and/or
c) receiving information of a monitoring mechanism (watchdog);
and initiating a self-destruction if
   i) no response of the cockpit server has been received;
   ii) an incorrect response has been received by the cockpit server;
   iii) a change in a script and/or hash value has been detected; and/or
   iv) an unallowable access has been detected;
wherein the self-destruction comprises the mixture of the underlying code of involved scripts, rendering the underlying code unusable and/or impossible to recover.

In the following the method and the functions are exemplary described in more detail:

An index.php file is provided by the creator for download for installation purposes. This file is preferably an installation program (wizard). Wizard as used in the following is an assistant or a software tool that guides users step by step through a complex task, such as installation or configuration. The wizard of the present invention contains all files that the target server needs to operate as encrypted code. Accordingly, in one step of the invention all necessary all files that the target server needs to operate are stored in the wizard. To ensure that the wizard is only installed on a designated server, in one embodiment a restriction is set based on the domain or IP address. Preferably, the restriction is defined in the cockpit server. If a restriction is set by IP address, i.e. a specific IP address is deposited, the wizard can be used on all domains with the same IP address, i.e., all domains of a server. A corresponding restriction is advantageous because, in the simplest case, a competitor can downgrade the domain in search engines by means of “duplicate content,” but in the worst case, can use the method or application as a man-in-the-middle with fraudulent intentions.

In one embodiment the wizard comprises data, files and/or other information in encrypted form.

These wizard data, files and information preferably contain the following:
index.php
Core.php
Fileobserver.php
Guardian.php
Iagent.php
Transport.php
.z.ini
.htaccess
.htpasswd

In one aspect, the data “index.php” is replaced by “Wizzard-index.php”. In one step of the method the “Wizzard-index.php” is transferred by the cockpit server to a target server using SFTP/FTP-information, which have been preferably stored in the cockpit server in a former step. If no SFTP/FTP-information are available in one embodiment a data-file “index.php” is offered for download and must be uploaded manually to the target server. This is an option, as some users are reluctant to disclose access data to third parties. The “index.php” has to been saved in the root directory of the domain. Preferably, the domain must be called up in the browser before a wizard starts. In one embodiment the wizard, when called, in a first step checks whether the domain belongs to the deposited or stored domain or whether the IP address belongs to the deposited or stored IP. In case, the information of the deposited domain and the domain or IP address does not match, the wizard will disable itself. In the event that the examination of the domain is correct, in a preferred embodiment all data, files, information belonging to the installation are deleted.

After cleaning up the directory, the files to be moved are written to a new directory. In a preferred embodiment, the current “Wizard-index.php” is replaced by the “Target-Server-index.php”. In one aspect of the invention, after the files have been installed, the stored domain is called up by wizard in a further step. Preferably, wizard then terminates itself. When the domain is called up again, a new “index.php” is executed in one embodiment so that the user sees the protected website. In a particular, the files “z.ini, .htaccess” and/or “.htpasswd” are stored as separate files on the target server. Furthermore, it may also be provided that the transport script with a so-called transport class is stored as a separate file on the target server. In one aspect of the invention, all other files and/or PHP classes relevant to the function of the website are stored as separate files or as a collection in one data file. Storage is preferably dependent on the location of use. For example, “all” may indicate that all PHP-classes are stored in one data file, e.g., the “index.php”; “ext” may indicate that each class is stored in a separate data file. Usually, the collection of all PHP-classes in one data file is used for plying out. However, the variant including separate data files is used for debugging. In a preferred embodiment the method comprises the encryption of the corresponding data files.

The contents of the individual files and/or PHP classes are preferably stored in encrypted form, preferably in a so-called code area. The code area is the lowest part of such a file and is preferably introduced by the text “//CODEAREA”. In a preferred embodiment, the respective code of each individual file is located within a comment with the name of the file.

For example, for Iagent:
/*Iagent.php
<CODE>
Iagent.php*/

In order to find the individual file, code or section, an array “$extractcodes” is used in one aspect in which the file names are stored. These stored sections are preferably read in and decrypted in a further step. Depending on the (playback) variant, the decrypted texts are written to the respective file, for example in the case of “ext”, or in the case of variant “all”, they are written to one data file, e.g., “index.php”, after decryption. In a preferred embodiment, PHP-based encryption is used for decryption. Such encryption has the advantage that no additional requirements are placed on PHP and/or the system. In a particularly preferred embodiment, one to five, in particular three keys are preferably required in the decryption step. These keys are preferably stored in the variable “$keys” as an array. In a preferred aspect, one of the keys have to be requested from the Cockpit server for decryption. In this context, it is particularly preferred that the domain and/or IP address be transmitted and checked in one step of the method, in particular to verify that the restriction is correct.

If no key is returned, it can be assumed that the restriction and/or the request hash do not match the domain information, IP addresses, and/or subdomains originally stored. If this is the case, the next step is preferably to initiate the destruction of the stored script.

In a particularly preferred embodiment, the “index.php” file has a special feature, namely that it is decrypted at the end. In a further step, it is also preferably stored as “index.php” in the “root”-directory. This step is particularly preferred to be performed from the currently running “index.php (Wizard-index.php)”, thereby replacing wizard.

In the following exemplary functions of the method and of wizard are described:
“clearDirectory( )”: This function preferably is called up to empty the complete “root” directory recursively, i.e. in a particular preferred aspect including all subdirectories. If the transferred parameter “$dir” is empty, the directory may be assumed. E.g.:
   Parameter:
   “$dir” directory, which should be emptied
   Return: none
“deleteFile( )”: This function preferably remove the data file which should be deleted by the function “clearDirectory( )”.
   Parameter:
   “$file” Data file, which should be removed
   Return: none
“decrypt( )”: This function decrypts Text “$text” which should be decrypted, preferably with the use of the keys transferred by “$keys”.
   Parameter:
   “$text” Code to be decrypted
   “$keys” Key-Array with keys, preferably with three keys
   Return: Decrypted text
“getDF( )”: This function calls the stored URL to retrieve the third key from the Cockpit server. The Cockpit server awaits a hash value as “GET” parameter and the IP address and domain as “POST” parameter. “GET” parameter refers to a HTTP method used by web browsers to send data to a server via the URL in order to request a resource. These parameters are passed as name-value pairs. They are useful for passing data dynamically in web applications, e.g. to filter search results or pre-fill forms. The “POST”-parameters are used to send data to a web server for processing, e.g., storage or updating. This data is transmitted in the message body of the request and is not visible in the URL, unlike GET parameters. POST is often used in HTML forms. Utilizing the “GET” and “POST” parameters the cockpit server is able to determine the correct key and preferably output the same. In a preferred embodiment the key may consist of a keyword or a code, such as a word, a letter or character string or the like. In a particular preferred aspect, the key begins with the keyword or code. If the code is not available in the response received within the “GET” and/or “POST” parameter by the cockpit server or if the nothing will be returned, the method initiates the step of self-destruction. In a particular, preferred embodiment the self-destruction comprise the initiation of the function “shuffle( )”.
   Parameter:
   “$url” URL to receive the cockpit server, preferably including also the “GET” parameter
   Return: Key code
“getKeys( )”: This function provides one or more keys, preferably, three keys, required by function “decrypt( )” as an array. The term “array” describes a data structure that stores a fixed number of elements of a uniform data type. Usually, individual elements are accessed via an index. In addition, the array enables the processing of many similar data items as a single unit. In a preferred embodiment, two of the three keys are stored in the function “getKeys( )”. The third key must be preferably requested using the function “getDF( )” from the cockpit server.
   Parameter:
   “$url” URL to receive the cockpit server, preferably including also the “GET” parameter
   Return: Key code for the array
“shuffle( )”: This function is called if the key is not returned when the last key, in particular, third key, is retrieved. Accordingly, the domain or IP-address of the current server is outside the IP address and/or domain stored in the cockpit server, or the request did not have the required format. In this case, the method described herein preferably initiates the self-destruction. The self-destruction comprises in one aspect a shuffling of underlying information of, e.g., files, data, information, and other contents required for executing the method, for example in form of an application, a computer program product or the like. In a preferred embodiment, in a first step the content of the wizard data file “index.php” is read with a PHP function “file_get_contents( )”. In a further step, the complete content or a part of the content of the data file “index.php” is mixed or shuffled using preferably the function “str_shuffle( )”. The shuffling may be performed utilizing the PHP function. According to a further embodiment, the created shuffled data file is stored, preferably using the PHP function “file_put_contents( )”, wherein the same name “index.php” may be used. As a last step the method may comprise an output of an error message.
   Parameter: none
   Return: none

Fraudsters are interested in receiving information about security systems in use. If the corresponding systems do not provide any usable information from the outside, as in the herein described method, fraudsters try to take control of the system in order to inspect it more closely. However, the method of the present invention realized that the wizard and/or the files of the target server are running on a wrong system. Accordingly, by using the shuffle function of the method described herein, the underlying codes are mixed up and thus becomes unusable for any fraudster.

In a preferred embodiment the method as described herein or one or more steps of the method described herein, is executed through one or more computer program products.

The invention therefore also relates to a system for protecting the integrity of data, in particular a distributed computer system, e.g. a distributed fractional computer system, comprising means for carrying out the steps of the method according to the invention as defined herein, wherein the individual steps are preferably realized together or individually in a distributed computer environment. Examples of such a system include a networked client-server system with a smartphone as a client having access to storing or processing resources in a computer cloud, file sharing by devices in a peer-to-peer network, an augmented reality environment with head-mounted displays, autonomous vehicles interacting via an ad hoc network or networked in a distributed ledger system using blockchain. Nevertheless, there may also be provided a computer program for protecting the integrity of the data comprising instructions which, when the program is executed by a computer, cause the computer to execute the method according to the invention, in particular the steps of the method, in each case as defined herein. The invention further comprises a computer-readable medium comprising instructions which, when executed by a computer, cause the computer to perform the method according to the invention, in particular the steps of the method, each as defined herein.

In a preferred embodiment of the invention, there is also provided such a computer program product, herein also referred to as a first computer program product, comprising instructions which, when the program is executed by a computer, cause the computer to perform the steps of generating (S01) an intended state (3) of data. In one embodiment the first computer program product comprising instructions to convert dynamic data into static data. In addition, it controls the transmission of the intended state data to the server in the insecure network either manually, time-controlled or automatically after the intended state of the data has changed. In particular, the intended state of data comprises an original state of data, which has been created by an original user. However, transmission of data from the primary computer comprises only original information to the frontend. This frontend information comprises, but are not limited to, information for visual design and interaction of a website, such as user interface (GUI), design, navigation, layout, displaying text, images, buttons, and/or menus. It is also capable of transmitting the intended state of the secondary computer system from the primary computer system either completely or as a differential update. Preferably, the first computer program is provided or arranged within a system, more preferably within a distributed computer system, for example within a distributed fractional computer system as defined herein.

Preferably, in the steps of generating the intended state (S01), the first computer program transfers frontend for an application, e.g. a website, to the secondary computer system. In a particularly preferred aspect, in the steps of generating the intended state (S01), the first computer program transfers supposedly dynamic data of the web service, such as HTML pages rendered by PHP, for example, to the secondary computer system as static files, such as HTML, JSON or XML files, to the extent permitted by the service being operated. Irrespective of this, it may be provided that the triggering of the transferring of data from the primary computer system (1) to a secondary computer system (7)
a) is triggered manually, or
b) is triggered automatically on a time-controlled basis, or
c) automatically after changing the intended state of the data is triggered.

In one embodiment of the invention, it may be provided that only the difference between the intended state and the previous intended state of the data is transferred from the primary computer system (1) to the secondary computer system (7) by the first computer program during the steps transferring of data (S02).

In one embodiment of the invention, it may be provided that the first computer program stores each change to an intended state (3) and each transfer to the secondary computer system in an audit-proof manner during the steps transferring of data (S02), thereby enabling subsequent auditing.

According to a particularly preferred embodiment, the first computer program may be set up to comprise instructions which, when the program is executed by a computer, cause the computer to perform the method according to the invention as defined herein.

In a further embodiment, the first computer program may comprise instructions for self-destroying to prevent misuse. Accordingly, the first computer program is connected, deposited or linked to one or more servers which are used, stored or deposited by the user. In a preferred aspect the user has to specify a domain or IP (Internet Protocol) address and/or may also indicate whether there will exist only one instance or several instances, for example for subdomains. Based on the information the first computer program will be preferably delivered in an installer version, such as an installer software. After installation of the computer program product, the method runs on a computer system with a defined domain or IP (Internet Protocol) address and/or one or more instances.

The first computer program comprise also instruction for i.e. contacting deposited server (cockpit server). Contact is preferably made at irregular intervals. These irregular intervals are, for example, preferably one or more per week, one or more per day, one or more per hour, more frequently than once per 30 minutes, more frequently than once per 10 minutes, in particular more frequently than once per 5 minutes, in particular more frequently than once per minute, in particular one or more times between a femtosecond and a second. In case
a) the cockpit server cannot be reached;
b) an incorrect response is received; and/or
c) a change to the source code of one of the data, information or files of the computer program product has been detected,
   the self-destruction function is triggered as described to the method before.

The invention further also comprises a computer-readable medium (data carrier) comprising the first computer program as defined herein, in particular for defining the intended state in S01 and/or verifying that the first computer program and/or method described herein are running on servers used, stored and/or deposited by the user.

Preferably, the primary computer system (primary system) comprises the first computer program product and/or the computer-readable medium comprising the first computer program product, which is a) set up to generate (S01) the intended status of the data, in particular according to the method as defined herein and/or b) set to verify that the first computer program and/or method described herein are running on servers used, stored and/or deposited by the user, in particular if a misused is detected preferably starting a self-destroying as described above. Preferably, the primary computer program product is provided or set up within a system, more preferably within a distributed computer system, for example within a distributed fractionated computer system, in each case as defined herein.

The invention also relates to such a computer program product, also referred to herein as a secondary computer program product, comprising instructions which, when the program is executed by a computer, cause the computer to implement the steps S03 and S04, i.e. the steps of checking (S03) and restoring (S04) as described above. Preferably, placing the manipulated data in quarantine is implemented, wherein checking the data by means of cryptographic methods is performed immediately after its manipulation and securing the database by one of the above-mentioned means. Should the secondary computer program be terminated, it is automatically restarted by the secondary computer system. Preferably, the first computer program product is provided or set up within a system, more preferably within a distributed computer system, for example within a distributed fractional computer system as defined herein.

According to a preferred embodiment of the invention, the secondary computer program detects changes in the data in the secondary computer system compared to the original data stored in the primary computer system, as an example of manipulation (17) of data, based on cryptographic methods.

It may be provided that the secondary computer program is set up to perform checking (S03) (20) of the integrity of the data (also referred to as checking), in particular of the information, data, files and/or parts of files, in particular frontend information comprising information to visual design and interaction of a website, such as user interface (GUI), design, navigation, layout, displaying text, images, buttons, and/or menus, immediately after manipulating (17) the data, in particular the information, data, files and/or parts of files. In a particularly preferred embodiment the information, data, files and/or parts of files comprise frontend information comprising information to visual design and interaction of a website, such as user interface (GUI), design, navigation, layout, displaying text, images, buttons, and/or menus, and/or changes in the underlying source code, wherein in particular the programming languages HTML, CSS, and/or JavaScript is used.

In one embodiment of the invention, it may be provided that the secondary computer program is set up in such a way that data defined by a user (e.g. files, parts of files and/or other data) are registered for checking (S03) for manipulations or data defined by a user (e.g. files, parts of files and/or other data) are excluded from checking (S03) for manipulations. These defined data may include all information on the secondary computer system, in particular information related to the frontend as described above.

According to a preferred embodiment of the invention, the secondary computer program is configured such that it comprises instructions for selecting the data for generating the web service from data in a database, wherein the integrity of the data in the database (4) is secured by
a) either each query to the database (13) is first checked, in particular by the agent (11), for malicious entries (e.g. SQL injections, or changes to prohibited data records, such as database users), then secured and transmitted (14) to the primary database (4) of the primary computer system (1) and subsequently the changes made are mirrored to the secondary database (9) in the secondary computer system (7), or
b) each request to the database (13) is first checked, in particular by the agent (11), for malicious input and then transmitted (14) in a secured manner to the primary computer system (1), and read accesses (15) to the database are also checked, in particular by the agent (11), and transmitted (16) to the primary computer system, so that no database is required in the secondary system (7), or
c) the database on the secondary system (9) is regularly checked, in particular by the agent (11), for changes to prohibited data records that are not to be processed by the web service (8), is checked.

According to a preferred embodiment of the invention, the secondary computer program product is designed such that it comprises instructions which allow the manipulated data to be analyzed by means of manual and automated data processing methods after manipulation has taken place.

Preferably, the secondary computer program is provided or set up within a system, more preferably within a distributed computer system, for example within a distributed fractionated computer system as defined herein.

According to a particularly preferred embodiment of the invention, all features of the method according to the invention, as defined herein, can be realized by the secondary computer program, as conceived.

The secondary computer program is preferably contained on a secondary computer-readable medium (data carrier).

The secondary computer program preferably protects a tertiary computer-readable medium (data carrier).

A secondary computer system preferably comprises a secondary and/or a tertiary medium. A medium may combine the properties of the secondary and the tertiary medium. Preferably, the computer program products of the present application are also themselves protected by a further computer program product so that they are themselves advantageously protected from manipulation.

A tertiary computer program preferably implements the transfer of the intended state of data from the primary to the secondary computer system. In a preferred embodiment, the intended state of data on the secondary computer system comprises information based on original information or data deposited in the primary computer system, while comprising only frontend information, i.e. information belonging to the backend, such information's to the functionality, source codes, data processing, databases, database management, authentication, logic, and/or connection to other systems are not transferred to the secondary computer system. It is part of a computer-readable medium and is executed either on the primary or a secondary or a further tertiary system. Preferably, the tertiary system is at least partially, in particular completely, protected by the primary and/or secondary, in particular by the secondary computer program as defined herein. The invention therefore preferably also comprises a tertiary computer program comprising instructions which, when the program is executed by a computer, cause the computer to implement the step of transmitting (S02) according to the method according to the invention.

According to a particularly preferred embodiment of the invention, all features of the method according to the invention, as defined herein, can be realized by the tertiary computer program—according to the concept.

According to a preferred embodiment of the invention, the tertiary computer program is configured such that it comprises instructions for selecting the data for generating the web service from data in a database, wherein the integrity of the data in the database (4) is secured by
a) either each query to the database (13) is first checked, in particular by the agent (11), for malicious entries (e.g. SQL injections, or changes to prohibited data records, such as database users), then secured and transmitted (14) to the primary database (4) of the primary computer system (1) and subsequently the changes made are mirrored to the secondary database (9) in the secondary computer system (7), or
b) each request to the database (13) is first checked, in particular by the agent (11), for malicious input and then transmitted (14) in a secured manner to the primary computer system (1), and read accesses (15) to the database are also checked, in particular by the agent (11), and transmitted (16) to the primary computer system, so that no database is required in the secondary system (7), or
c) the database on the secondary system (9) is regularly checked, in particular by the agent (11), for changes to prohibited data records that are not to be processed by the web service (8), is checked.

According to a preferred embodiment, the tertiary computer program is designed in such a way that several secondary systems are operated in parallel in order to advantageously enable load balancing of the web application. In addition to load balancing, protection against (D) DoS may also be implemented.

According to a preferred embodiment, the tertiary computer program is configured to comprise instructions whereby, upon violation of the integrity of a datum, the entire secondary system or the multiple secondary systems on which the integrity has been corrupted is/are isolated.

According to a preferred embodiment, the tertiary computer program is configured to comprise instructions whereby the isolated secondary system or the plurality of isolated secondary systems is/are not terminated but continues to operate in isolation for the purpose of analysis of the malware.

It may be envisaged that the tertiary computer program is designed to comprise instructions whereby, after isolating the (compromised) system whose integrity has been damaged, another secondary system is started as a replacement system.

According to a preferred embodiment, the tertiary computer program is designed in such a way that a reverse proxy is used on the secondary system in order to protect the web service (8) advantageously from (D)DoS attacks.

The tertiary computer program is preferably contained on a tertiary computer-readable medium (data carrier).

Preferably, a tertiary computer system (primary system) comprises the tertiary computer program product and/or the tertiary computer-readable medium comprising the tertiary computer program product set up for transmission (S02) within the method according to the invention. Preferably, the tertiary computer system is provided or set up within a system, more preferably within a distributed computer system, for example within a distributed fractional computer system as defined herein.

The invention may also relate to a computer program product, also referred to herein as a fourth computer program product, comprising instructions which, when the program is executed by a computer, cause the computer to implement a self-destroying if a misuse is detected, as described herein. In a preferred embodiment, the fourth computer program product is verifying whether the deposited server (cockpit server) is identical with the one used, stored or deposited by the user. For this reason, the user has to specify a domain or IP (Internet Protocol) address and/or may also indicate whether there will exist only one instance or several instances, for example for subdomains, as described above. In one aspect of the present invention deposited server (cockpit server) is preferably contacted in regular or irregular intervals. In case
a) the cockpit server cannot be reached;
b) an incorrect response is received; and/or
c) a change to the source code of one of the data, information or files of the computer program product has been detected,
   the self-destruction function is triggered, as described herein. The self-destruction preferably comprises a “shuttle( )” function, wherein underlying code of all involved scripts of the underlying method and/or computer program product, preferably using the PHP function “str_shuffle( )”, are destroyed due a change in the source codes and make unusable and/or impossible to recover.

The computer programs can also be extended with plugins to add further functionalities for operating and improving a web service. For example, a plugin could be added for the processing and analysis of the generated data traffic, whereby this service advantageously does not have to be provided by a third-party provider and other aspects of data economy and data protection can be maintained by keeping the information with the operator of the web service.

The invention also comprises a network comprising a computer system, in particular a system for protecting the integrity of data, in particular a distributed computer system, e.g. distributed fractional computer system, as defined herein, and/or a primary computer system, a secondary computer system and/or a tertiary computer system, each as defined herein.

Several methods can be used to ensure that the computer program(s) themselves are not manipulated, which would invalidate the protection. These make it more difficult to change the functionality of the computer program product so that protection is further increased.

On the one hand, the computer program used to implement the method can monitor the folder structure or the medium in which it is stored. While it is stored in the computer's working memory, it is strongly protected against manipulation. If the program itself is modified on the medium, it can detect the change and restore itself. Furthermore, the program can be stored on a medium that cannot be rewritten, e.g. an EPROM or an SD card with write protection.

Furthermore, many operating systems already protect parts of their directory structure in such a way that they can only be written to in safe mode and otherwise cannot even be modified by the system itself. The computer program could be stored in such a part of the directory structure while using safe mode in order to continue to protect it advantageously.

It is also possible to manipulate the computer program in the working memory. The structure of the program in the working memory could be detected by a specialist, who could then search for the program in the memory and manipulate it by exploiting other vulnerabilities, such as buffer overflows. By taking targeted measures, the computer program can make such attacks more difficult. To do this, it fills random memory areas with random contents to make analysis and manipulation of the instructions contained in the program more difficult by changing their position with each execution and over time. Further advantageous embodiments and further developments can be seen from the subclaims and from the description with reference to the figures.

### DESIGN EXAMPLES

With reference to the following figures and embodiments, the present invention will be explained in more detail, without limiting the invention to these.

This shows

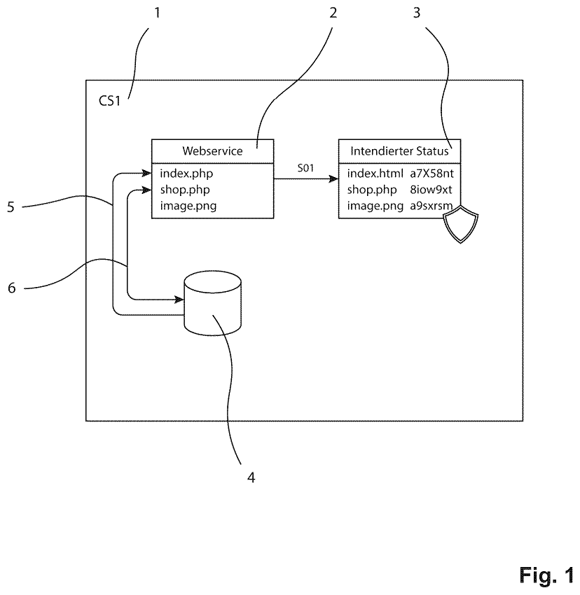

FIG. 1: a schematic representation of the primary computer system CS1 5 (1). Shown is a web service (2) running on CS1 with dynamic content (“index.php” and “store.php”) and a static image file (image.png). Both dynamic files use the database (4), but the file “index.php” (5) reads data from the database (4), which does not change in this example. Therefore, the file “index.php” can be converted to a static file (index.html) by a computer program according to claim 17 (S01). The file “store.php” reads and writes (6) data from and to the database (4). Therefore, it cannot be converted into a static file. Nothing changes in the already static file either. This results in the intended state of the web service files (3). Furthermore, the hashes, indicated by alphanumeric character strings next to the file names, are calculated and stored in 15 step S01. The shield is intended to illustrate the corresponding backup of the files.

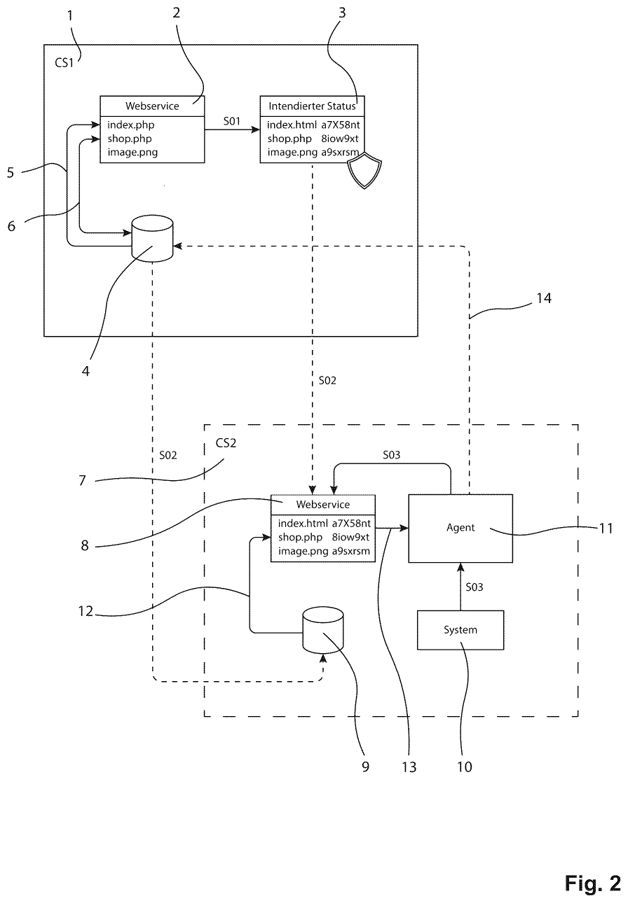

FIG. 2: A schematic representation of the CS1 (1) from FIG. 1 together with a second, secondary system CS2 (7) in an insecure network. S02 transfers the intended state (3) of the database (4) and the files of the web service (2) to the secondary system (7). An agent (11) takes action in the event of changes to the data at file system level (reported by the operating system (10)) or at regular intervals to check the integrity of the data of the web service (2). Changes to the database (4) (in the example by the file “store.php”) are checked (13) by the agent (11) before it transfers (14) these changes to the database (4) in the primary system (1) and these are again entered into the secondary database (9) of the secondary system (7) by S02. The dynamic files (in the example the file “store.php”) read (12) the necessary data from the database in the secondary system (9). Step S03, the checking of the files of the secondary web service (8) by the agent (11) after manipulation, is triggered either time-controlled or by a watchdog.

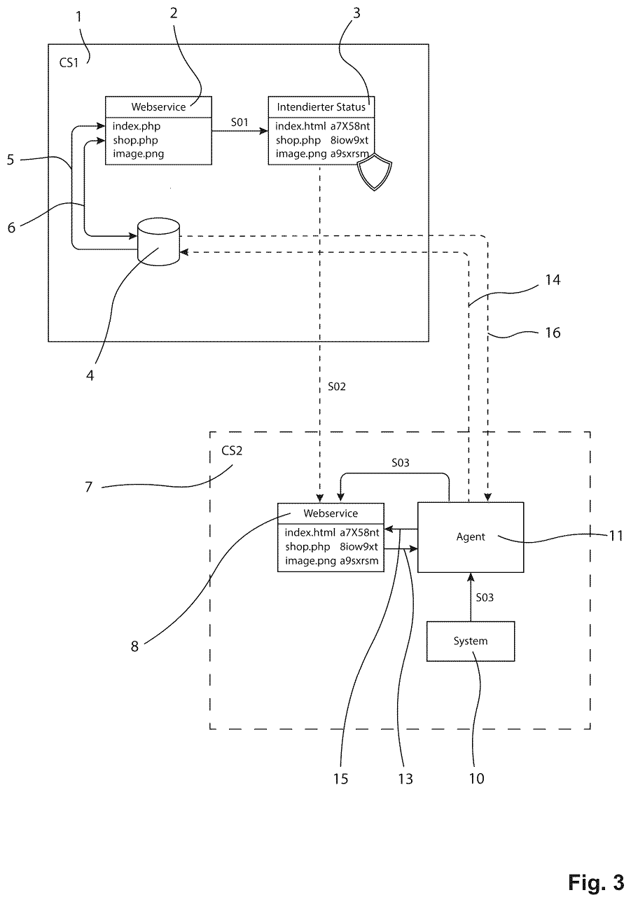

FIG. 3: A schematic representation of the primary computer system (1) and the secondary 30 computer system (7). In this case, there is no database in the secondary system (7). S02 transfers the intended state (3) of the files of the web service (2) to the secondary system CS2 (7). Once again, the operating system (10) triggers step S03 either when the data changes (via a watchdog) or in a time-controlled manner, whereupon the agent (11) compares the files of the web service (8) in the secondary system (7) with the intended data (3) of the primary system (1). Since the secondary database is omitted, the read access (15) of files such as the “store.php” to the database (4) of the primary system (1) is performed by the agent (11) (16). Write access (13) is checked by the agent (11) as in FIG. 2 and then transferred (14) to the primary database (4).

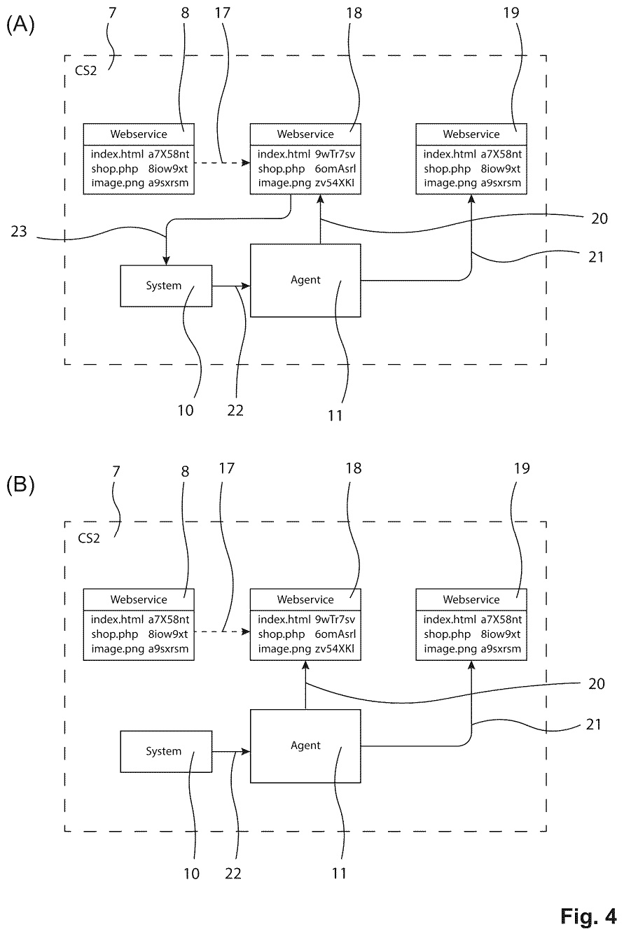

FIG. 4: Schematic representation of how the agent (11) acts in the 5 event of undesired manipulation (17 of the files (S04)).

A) The method using a watchdog: In this case, the operating system (10) reacts (23) to the change in the files of the web service (8) and informs (22) the agent (11). This agent checks (20) all files of the web service in the possibly manipulated state (18). After detecting a change by means of a cryptographic method, in this case by means of a hash value, it restores (21) the desired file states (19) and places the manipulated files (18) in quarantine for later analysis.

B) In this case, the operating system (10) regularly reports (22) the system time or the exceeding of a certain time interval to the agent (11), which checks (20) the current state of the files of the web service (18) and, after an undesired manipulation (17), comes to the conclusion that they have been manipulated, whereupon it restores (21) the desired state of the files and, if necessary, places the manipulated files (18) in quarantine for later analysis.

Common to all embodiments is the fact that the primary computer system CS1 (1) can only be reached by the agent (11) via a secure connection. The web service (2) of the primary system (1) is only necessary to establish the intended state (3) and to be able to convert supposedly dynamic files into static files (e.g. by rendering HTML through a PHP file). The intended state can be determined in step S01 using various cryptographic methods. FIGS. 2 and 3 differ only in the use of the database, in particular in how the integrity of the data in the database is secured.

In principle, there can be any number of secondary systems (7), even if this is not shown graphically. In the configuration with a secondary system (7), the agent (11) also serves as a reverse proxy to protect against DDoS attacks, so that the secondary systems (7) do not have direct access to the web services (8) of the secondary system (7).

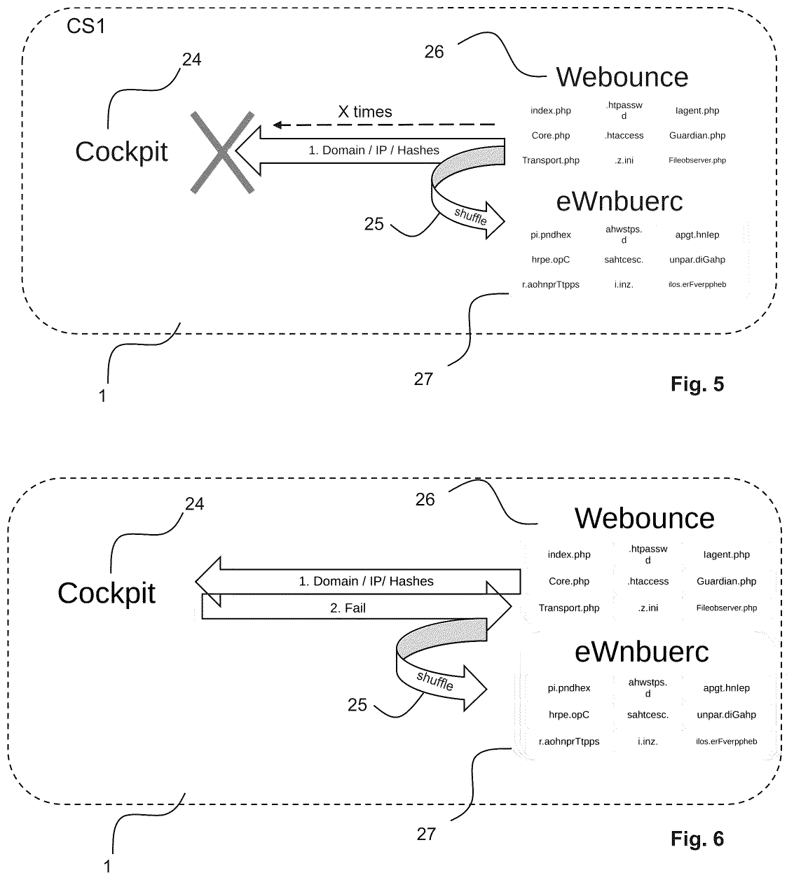

FIG. 5-7: A schematic representation of the self-destroying.

FIG. 5: A schematic representation of the self-destroying in case the primary system or the cockpit server cannot be reached.

The availability the deposited cockpit server (24) is checked regularly or irregularly. If the cockpit server (24) cannot be reached several times. i.e., the cockpit server is unavailable for a certain period of time (timeout), self-destruction (25) is initiated. During self-destruction, a so-called “shuttle( )” function is preferably started. This function shuffles the entire code (source code) of all involved scripts, in particular using the PHP function “str_shuffle( )”, rendering entire code of all involved scripts of the computer program product unusable and/or impossible to recover. Accordingly, the method described herein cannot be used anymore.

FIG. 6: A schematic representation of the self-destroying if an incorrect response is received. The method or the computer program product contacts the deposited server by the user (cockpit server, 24) in regular or irregular intervals. In case an irregularity (fail) is detected, self-destruction (25) is initiated. This function shuffles the entire code (source code) of all involved scripts, in particular using the PHP function “str_shuffle( )”, rendering entire code of all involved scripts of the computer program product unusable and/or impossible to recover. Accordingly, the method described herein cannot be used anymore.

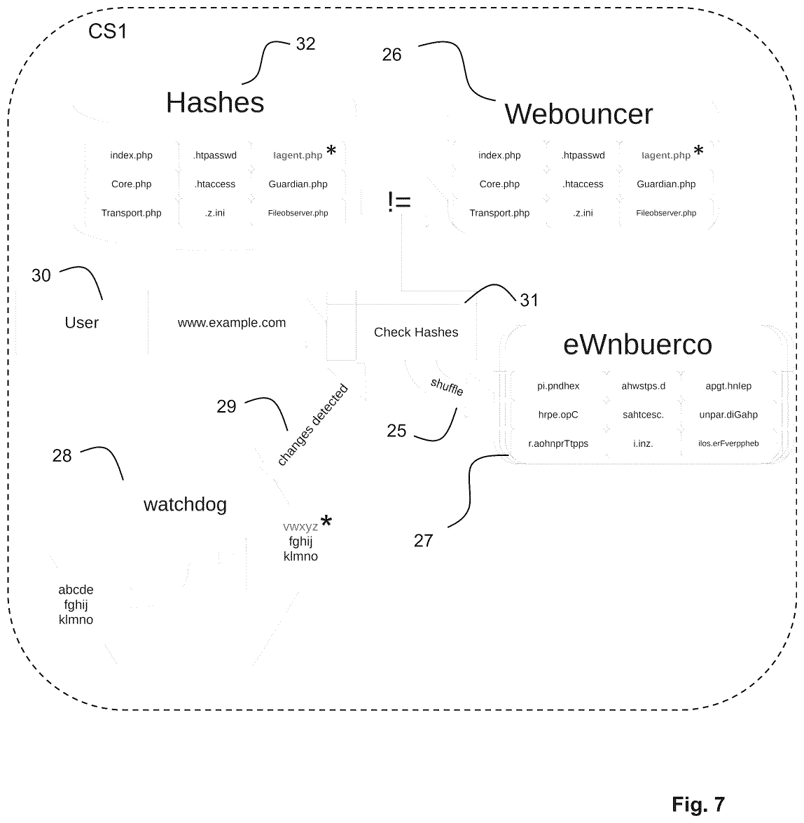

FIG. 7: A schematic representation of the self-destroying if a change to the source code of one of the data, information or files has been detected.

The user (3) may request a verification of the Fileserver.php script and the underlying hash values (32). If this internal verification function detects changes (*) compared to the stored hash values in the original system or method (webouncer, 26), the self-destroy function (25) is initiated.

In addition, a watchdog (28) may be available, which checks whether a change has been taken place and/or whether someone tried to accesses a file of the computer program product or system. If a change and/or unallowable access has been registered the self-destroying (25) is initiated, rendering the Fileserver.php script or the source code of the application unusable (27).

### REFERENCE LIST

1 Computer system 1 (primary system) or cockpit server
2 Web service on the primary system
3 Intended status of the web service files after reduction to static files (S01) by the primary computer program
4 Database of the web service on the primary system
5 Read access of the “index.php” file to the database
6 Read/write access of store.php to the database
7 Computer system 2 (secondary system)
8 Web service with the intended state of the files after step S02
9 Database on the secondary system, with desired state synchronized by S02
10 Operating system mechanism for starting the test (S03) (watchdog or timer)
11 Agent running on computer system 2 (secondary computer program)
12 Read access of the file “store.php” from the database of the secondary system
13 Write access of the file “store.php” sent to the agent (14)
14 Write access of the file “store.php” after the check to the agent to update the desired state of the database of the primary system
15 Read access of the file “store.php”, where the agent reads directly from the database of the primary system (16) without first mirroring it to a secondary database
16 Read access of the agent triggered by the read access of the file “store.php” (15) Checked by the agent (11)
17 Manipulation of the web service files
18 Manipulated web service
19 Web service in the restored intended state
20 Determining the manipulated state of the files by the agent
21 Restoring the intended state by the agent with deletion of the manipulated files or preferably placing the files in the manipulated state in “quarantine”
22 Signal from the system to the agent that a file has been changed (watchdog) or a time interval has elapsed (timer)
23 Registering the file change with the system
24 Cockpit server
25 Self-destroying by shuffling
26 Fileserver.php script or the source code of the application to perform a method of the present invention or computer program product performing the method described herein, i.e. to safe an intended stat of data on a secondary computer system
27 Shuffled source code of the computer program product 26
28 Monitoring mechanism (watchdog) that regularly checks a monitored system by requiring the system to send a signal to the watchdog to show that it is still functioning.
29 Errors and/or changes detected in the system
30 User requests a verification
31 Verification of Fileserver.php script changes compared to the stored hash values, if changes are detected a self-destroying is initiated
32 Potentially changed Hash values

What is claimed:

1. A method of protecting the integrity of data comprising the following steps:
a) running a web service on a primary, secure computer system including an original, complete data set created by the user;
b) generating an intended state of the data of the web service on the primary, secure computer system, wherein the intended state of data comprises frontend data, files and information relevant for visual design and interaction of the web service;
c) transferring the intended data set through a secure connection to one or more secondary computer systems in a potentially insecure network on which the web service is executed;
d) checking the integrity of the intended data set by detecting manipulation of the underlying information of the intended data by an attacker, wherein after manipulation, the manipulated data is placed in quarantine and may be analyzed in a further step but is no longer executed and thus cannot cause any damage; and
e) restoring the intended state of the data at the time before manipulation by transferring the intended data set stored on the primary computer system to one or more secondary computer systems, wherein a manipulation of data has been detected.

2. The method according to claim 1, wherein the method comprises a self-destruction function, comprising the following steps:
a) contacting a deposited server (cockpit server);
b) receiving and reviewing responses of a cockpit server;
c) verifying an underlying script or several scripts;
and/or
d) receiving information of a monitoring mechanism (watchdog);
and initiating a self-destruction if
i) no response of the cockpit server has been received;
ii) an incorrect response has been received by the cockpit server;
iii) a change in a script and/or hash value has been detected; and/or
iv) an unallowable access has been detected.

3. The method according to claim 2, wherein the contacting the deposited server (cockpit server) is made at regular or irregular intervals.

4. The method according to claim 2, wherein the availability of the cockpit server (response) is checked several times.

5. The method according to claim 2, wherein the verification of the underlying script or several scripts is performed after receiving a user's request.

6. The method according to claim 5, wherein the underlying script is the Fileserver.php script.

7. The method according to claim 2, wherein the self-destruction comprises the mixture of an underlying code of involved scripts, rendering the underlying code unusable and/or impossible to recover.

8. The method according to claim 7, wherein the PHP function “str_shuffle( )” is used rendering the underlying code of involved scripts unusable and/or impossible to recover.

9. The method according to claim 1, wherein data defined by a user is registered for checking for manipulations, or data defined by a user is excluded from checking for manipulations.

10. The method according to claim 1, wherein checking the integrity of the intended data set is performed immediately after manipulating the intended data set.

11. The method according to claim 1, wherein triggering the transferring of the intended data set from the primary computer system to the one or more secondary computer systems
a) is triggered manually, or
b) is triggered automatically on a time-controlled basis, or
c) is triggered automatically after changing the intended state of the data.

12. The method according to claim 1, wherein the data for generating the web service is selected from a database, and wherein the integrity of the data in the database is secured, wherein
a) either each query to the database is first checked for corrupt entries, then transmitted in a secured manner to the primary database of the primary computer system and subsequently the changes made are mirrored to a secondary database in the secondary computer system, or
b) each request to the database is first checked for malicious entries and then transmitted in a secured manner to the primary computer system, and read accesses to the database, in particular by an agent, are also checked and transmitted to the primary computer system, so that no database is required in the secondary system, or
c) the secondary database in the one or more secondary computer systems is checked regularly for changes to prohibited data records that should not be edited by the web service.

13. The method according to claim 1, wherein in the step transferring of the intended data set only the difference of the intended state to the temporally preceding intended state of the data set is transferred from the primary computer system to the secondary computer system.

14. The method according to claim 1, wherein a reverse proxy is used on the one or more secondary computer systems to advantageously protect the web service from (D)DoS attacks.

15. The method according to claim 1, wherein several secondary computer systems are operated in parallel in order to advantageously enable load balancing, in particular of the web application.

16. The method according to claim 1, wherein upon violation of the integrity of a datum, the entire secondary computer system on which the integrity has been damaged is isolated.

17. The method according to claim 1, wherein the isolated secondary computer system is not terminated but continues to operate in isolation for the purpose of analyzing malware.

18. The method according to claim 1, wherein after isolating the secondary computer system whose integrity has been damaged, another secondary computer system is started as a replacement system.

19. The method according to claim 1, wherein, in addition to load balancing, protection against (D) DoS is implemented.

20. The method according to claim 1, wherein after manipulation of the data of the intended data set has been performed, the manipulated data is analyzed by manual and automated data processing methods.

21. The method according to claim 1, wherein the method is executed through a computer program product, and wherein data defined by a user is registered for checking for manipulations, or data defined by a user is excluded from checking for manipulations.

22. The method according to claim 2, wherein the method is executed through a computer program product, and wherein the contacting the deposited server (cockpit server) is made at regular or irregular intervals.
